(19) United States
(12) Patent Application Publication
(10) Pub. No.: US 2003/0173223 A1
(43) Pub. Date: Sep. 18, 2003

(54) Wall-less channels for fluidic routing and confinement

(75) Inventors: Peter R.C. Gascoyne, Bellaire, TX (US); Jody Vykoukal, Houston, TX (US); Frederick F. Becker, Houston, TX (US)

Correspondence Address: Michael C. Barrett, FULBRIGHT & JAWORSKI, L.L.P., Suite 2400, 600 Congress Avenue, Austin, TX, 78701, US

(73) Assignee: Board of Regents,The University of Texas System

(21) Appl. No.: 10/336,611

(22) Filed: Jan. 3, 2003

Related U.S. Application Data
(60) Provisional application No. 60/345,490, filed on Jan. 4, 2002.

(51) Int. Cl. G01N 27/403; G01N 27/453

(52) U.S. Cl. 204/547; 204/643

(57) ABSTRACT

Methods and apparatuses for providing wall-less virtual channels. The wall-less channels may be regions such as stripes or other patterns that are defined by polar surface coatings. These wall-less channel may be used with polar solvents and defined by polar surface patterning of narrowly separated top and bottom walls of a chamber filled elsewhere by a non-polar partitioning medium. This provides a simple and easy-to-fabricate interface between the micro and macro worlds in which microfluidic processes are separated from the macro world fluid flow by a narrow veil of immiscible fluid across which an exchange of droplets can be controlled electrically.

This patent application claims priority to, and incorporates by reference, U.S. provisional patent application Serial No. 60/345,490 filed on Jan. 4, 2002 entitled, “Wall-less Channels for Fluidic Routing and Confinement.”

### BACKGROUND OF THE INVENTION

I. Field of the Invention

The present invention relates generally to fluidic processing. More particularly, it provides apparatuses and methods for the routing and confinement of fluid without the need for walls.

II. Description of Related Art

Conventionally, fluids are handled in processing equipment by confining them to tubes and other passageways and reservoirs that are surrounded by solid walls. In the case of a tube, for example, the wall may be metal, plastic, rubber, or some other solid material that constrains liquid flow. However, this can be problematic in microfluidic systems because of the potential fouling of the system, especially at inlet and outlet ports. Another limitation of using solid walls is that the range of reactions defined by the hard- wired tubing configuration is limited and pre-defined.

A significant innovation is the programmable fluid processor (PFP) which uses a two-dimensional surface on which droplets can cross, allowing arbitrarily programmable routing, a capability absent in hard-wired channels and one-dimensional track schemes. U.S. Pat. No. 6,294,063, herein incorporated by reference, discloses this concept of a two-dimensional reaction space in which reagents may be introduced and manipulated in the form of droplets, or packets. This scheme has the advantage that, using an appropriate mechanism for manipulating the droplets, reagents may be transported anywhere over the reaction surface according to predetermined paths and brought together with other droplets in order to fuse and initiate reactions. As a result, such a reaction surface allows for programmability because many different types of reactions can be undertaken in a programmable manner, either sequentially or, if the reaction surface is sufficiently large, simultaneously. This represents a significant advantage over conventional, tube-based systems that are constrained to a very limited range of reactions that are defined by the hard-wired tubing configuration. In order to realize a device capable of conducting reactions using droplet-based methods, it is helpful to provide a mechanism to introduce droplets and usually, a method to remove droplets from the reaction surface to recover the reaction products. In U.S. patent application Ser. No. 09/883,109 entitled “Apparatus and method for fluid injection,” filed Jun. 14, 2001, which is incorporated herein by reference, dielectrically activated injectors that form droplets under electrical control are described. These injectors allow droplets at injector tips containing unpressurized fluid to be withdrawn from the injector tip by using, among other factors, the intrinsic pressure of the droplet.

Other technology relating to droplets and/or dielectrophoresis has recently been reported by Fuhr (Schnelle et al., 2000; Fiedler et al., 1998), Pethig (U.S. Pat. Nos. 5,653,859; 5,993,631; 5,795,457 and 5,814,200) and others (Washizu et al., 1993; Green et al., 1997), all of which are incorporated herein by reference. The use of two dimensional electrode arrays has been demonstrated by Nanogen, Inc, (U.S. Pat. Nos. 6,071,394; 6,099,803 and family, each of which is incorporated herein by reference) in which two-dimensional arrays are (a) used to trap and cause migration of DNA and (b) for dielectrophoretic trapping of cells in 2D. U.S. Pat. No. 6,130,098 to Handique, which is incorporated herein by reference, describes a method for moving microdroplets where liquid moves through an etched transport channel and stops at a hydrophobic region. Bachelder (U.S. Pat. No. 4,390,403, which is incorporated herein by reference) describes aspects of dielectrophoresis and aqueous droplets.

Modifying opposing surfaces with hydrophilic and hydrophobic areas for containing fluid is known for certain specific applications. U.S. Pat. Nos. 6,071,394; 5,904,824, German Patent No. 29908348 and Gau et al., 1999, each of which is incorporated herein by reference, describe hydrophobic and hydrophilic patterns that are used in a specific way to channel fluids; however, these methods and devices do not allow for the routing of fluid into or out of different regions of a biochip or other device. Rather, they are designed to move a fluid from one end of a column to the other. Other groups have used the interaction of hydrophilic and hydrophobic areas with fluid in physical channels. For instance, Zhao et al., (2001) and U.S. Pat. No. 6,130,098, each of which is incorporated by reference, describe aspects of this type of technology. In all cases droplets were moved along set tracks and were spatially confined in one dimension.

In light of the above, it would be advantageous to provide for technology in which surfaces having differing surface energies could be used to create a wall-less channel for the routing and confinement of fluids such that the fluids could be moved into and out of the wall-less channel at arbitrarily chosen locations without the need of either walls or injector tips.

Any problems or shortcomings enumerated in the foregoing are not intended to be exhaustive but rather are among many that tend to impair the effectiveness of previously known techniques. Other noteworthy problems may also exist; however, those presented above should be sufficient to demonstrated that apparatus and methods appearing in the art have not been altogether satisfactory and that a need exists for the techniques disclosed herein.

### SUMMARY OF THE INVENTION

In one embodiment, the invention involves an apparatus for routing a fluid packet including a top surface, a bottom surface, and a programmable manipulation force. The top surface includes a polar pathway and a non-polar region. The bottom surface includes a polar pathway and a non-polar region. The polar pathway of the top surface is above the polar pathway of the bottom surface, forming a polar channel. The programmable manipulation force is configured to move a packet into and out of fluid contact with the polar channel.

In another embodiment, the invention involves a method for fluid routing. A polar fluid is flowed through a polar channel. A packet is manipulated in a non-polar region of the polar channel, and the packet is subjected to a manipulation force. The packet fuses with the polar fluid in said polar channel.

In another embodiment, the invention involves a method for fluid routing comprising: flowing a polar fluid through a polar channel including a top surface including a polar pathway surrounded by a non-polar region and a bottom surface including a polar pathway surrounded by a non-polar region; wherein the polar pathway of the top surface is directly above the polar pathway of the bottom surface, forming a polar channel; and subjecting a portion of the polar channel to a manipulation force wherein a portion of the polar fluid moves from the polar channel into the non-polar region defining a packet of polar fluid.

Definitions

As used herein, a “carrier fluid” refers to matter that may be adapted to suspend other matter to form packets on a reaction surface. A carrier fluid may act by utilizing differences in hydrophobicity between a fluid and a packet. For instance, hydrocarbon molecules may serve as a carrier fluid for packets of aqueous solution because molecules of an aqueous solution introduced into a suspending hydrocarbon fluid will strongly tend to stay associated with one another. This phenomenon is referred to as a hydrophobic effect, and it allows for compartmentalization and easy transport of packets. A carrier fluid may also be a dielectric carrier liquid which is immiscible with sample solutions. Other suitable carrier fluid include, but are not limited to, air, aqueous solutions, organic solvents, oils, and hydrocarbon.

As used herein, a “partitioning fluid” refers to any matter that may be adapted to suspend and compartmentalize other matter to form packets on a reaction surface or a veil between two fluids. A partitioning fluid medium may act by utilizing differences in hydrophobicity between a fluid and a packet. For instance, hydrocarbon molecules may serve as a partitioning medium for packets of aqueous solution because molecules of an aqueous solution introduced into a suspending hydrocarbon fluid will strongly tend to stay associated with one another. This phenomenon is referred to as a hydrophobic effect, and it allows for compartmentalization and easy transport of packets upon or over a surface. A partitioning fluid may also be a dielectric carrier liquid which is immiscible with sample solutions. Other suitable partitioning fluids include, but are not limited to, air, aqueous solutions, organic solvents, oils, and hydrocarbons.

As used herein, an “immiscible fluid” refers to any matter that does not mix with the surrounding fluid, and can be used as a partitioning fluid. For example, the immiscible fluid may be an aqueous solution surrounded by a hydrocarbon partitioning medium.

As used herein, a “programmable fluid processor” (PFP) refers to a device that may include an electrode array whose individual elements can be addressed with different electrical signals. The addressing of electrode elements with electrical signals may initiate different field distributions and generate dielectrophoretic or other manipulation forces that trap, repel, transport, or perform other manipulations upon packets on and above the electrode plane. By programmably addressing electrode elements within the array with electrical signals, electric field distributions and manipulation forces acting upon packets may be programmable so that packets may be manipulated along arbitrarily chosen or predetermined paths.

In one embodiment, the electrode array of the PFP may contain individual elements which can be addressed with DC, pulsed, or low frequency AC electrical signals (typically, less than about 10 kHz) electrical signals. The addressing of electrode elements with electrical signals initiates different field distributions and generates electrophoretic manipulation forces that trap, repel, transport or perform other manipulations upon charged packets on and above the electrode plane. By programmably addressing electrode elements within the array with electrical signals, electric field distributions and electrophoretic manipulation forces acting upon charged packets may be programmable so that packets may be manipulated along arbitrarily chosen or predetermined paths. Electrophoretic forces may be used instead of, or in addition to, other manipulation forces such as dielectrophoresis-generated forces.

In one embodiment, a programmable fluid processor (PFP) can be configured to act as a programmable manifold that controls the dispensing and routing of all reagents. As used herein, a “program manifold” describes the combination of computer controlled forces and systems which are used to control the movement of fluids and packets through a biochip. The computer controlled forces may be, for example, dielectric forces or magnetic forces. The movements of fluids and packets may be used to: move fluids or packets within a biochip, manipulate fluids or packets into or out of the biochip; initiate or propagate a reaction, separate different components or other function, etc. The PFP may also be coupled to an impedance sensor which can be used to track particle position.

As used herein, a “biochip” refers to a biological microchip which can be described as a nucleic acid biochip, a protein biochip, a lab chip, or a combination of these chips. The nucleic acid and protein biochips have biological material such as DNA, RNA or other proteins attached to the device surface which is usually glass, plastic or silicon. These biochips are commonly used to identify which genes in a cell are active at any given time and how they respond to changes. The lab chip uses microfluidics to do laboratory tests and procedures on a micro scale. A design of a biochip that is a PFP-based general-purpose bioanalysis apparatus is termed a “BioFlip.”

As used herein, an oligonucleotide synthesis engine (OSE) is a microfluidic device that exploits a wide range of effects that become dominant on the microfluidic scale including the hold-off properties of capillary tubes; the high pressures intrinsic to tiny droplets; the tendency of droplets to fuse and rapidly mix on contact with miscible solvents; the attractive and repulsive characteristics of surface energies for fluids in microfluidic spaces; and the ability of inhomogeneous AC electrical fields to actuate droplet injection and the trapping, repulsion and transport of dielectric particles. These effects can be used to realize a programmable fluid processor (PFP) based on the dielectrophoretic (DEP) injection and manipulation of droplets within an immiscible carrier fluid over a reaction surface consisting of a Teflon-coated, addressable electrode array.

As used herein, “packet” and “particle” both refer to any compartmentalized matter. The terms may refer to a fluid packet or particle, an encapsulated packet or particle, and/or a solid packet or particle. A fluid packet or particle refers to one or more packets or particles of liquids or gases. A fluid packet or particle may refer to a droplet or bubble of a liquid or gas. A fluid packet or particle may refer to a droplet of water, a droplet of reagent, a droplet of solvent, a droplet of solution, a droplet of sample, a particle or cell suspension, a droplet of an intermediate product, a droplet of a final reaction product, or a droplet of any material. An example of a fluid packet or particle is a droplet of aqueous solution suspended in oil. The packet or particle may be encapsulated or a solid. Examples of solid packets or particles are a latex microsphere with reagent bound to its surface suspended in an aqueous solution, a cell, a spore, a granule of starch, dust, sediment and others. Methods for producing or obtaining packets or particle as defined herein are known in the art. Packets or particles may vary greatly in size and shape, as is known in the art. In exemplary embodiments described herein, packets or particles may have a diameter between about 100 nm and about 1 cm.

As used herein, an “array” refers to any grouping or arrangement. An array may be a linear arrangement of elements. It may also be a two dimensional grouping having columns and rows. Columns and rows need not be uniformly spaced or orthogonal. An array may also be any three dimensional arrangement.

As used herein the specification, “a” or “an” may mean one or more. As used herein in the claim(s), when used in conjunction with the word “comprising”, the words “a” or “an” may mean one or more than one. As used herein “another” may mean at least a second or more.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic drawing of a unit module containing a programmable fluidic processor, a channel extending through the module and other chip-based sections according to one embodiment of the present disclosure.

### DESCRIPTION OF ILLUSTRATIVE EMBODIMENTS

Techniques presented in this disclosure overcome deficiencies in the art by providing, among other things, an apparatus and method for the routing and confinement of fluids without the need for either walls or injector tips.

### I. DIELECTROPHORETIC FLUIDIC SYSTEMS

The wall-less channels of the current disclosure can be used with, for example, the apparatus described in pending U.S. Pat. No. 6,294,063 entitled, “Method And Apparatus for Programmable Fluidic Processing,” which has been incorporated herein by reference. This patent discloses techniques that relate to the manipulation of a packet of material using a reaction surface, an inlet port, means for generating a programmable manipulation force, a position sensor, and a controller. In one embodiment of that disclosure, material is introduced onto the reaction surface with the inlet port. The material is compartmentalized to form a packet and the position of the packet is sensed and tracked with the position sensor. A programmable manipulation force (which, in one embodiment, may involve a dielectrophoretic force) is applied to the packet at a certain position with the means for generating a programmable manipulation force, which is adjustable according to the position of the packet by the controller. The packet may then be programmably moved according to the programmable manipulation force along arbitrarily chosen paths. One or more packets of material may be introduced onto a reaction surface by the methods of the current disclosure instead of using a material inlet port. Similarly, once the packet has entered the reaction surface, reagents and other reacting media can be brought in contact with the packet for a reaction or analysis procedure. The programmable fluidic processor (PFP) can be used for injection, valving, metering and programmable routing of oligonucleotides, small molecules, and other substances. Both PFP and injector technologies may be adapted for polar solvents suitable for, for example, oligonucleotide synthesis and bead delivery and can be used with the wall-less channels of the current disclosure.

Other patents and applications that may be used in conjunction with techniques of the current invention include U.S. Pat. No. 5,858,192, entitled “Method and apparatus for manipulation using spiral electrodes,” filed Oct. 18, 1996 and issued Jan. 12, 1999; U.S. Pat. No. 5,888,370 entitled “Method and apparatus for fractionation using generalized dielectrophoresis and field flow fractionation,” filed Feb. 23, 1996 and issued Mar. 30, 1999; U.S. Pat. No. 5,993,630 entitled “Method and apparatus for fractionation using conventional dielectrophoresis and field flow fractionation,” filed Jan. 31, 1996 and issued Nov. 30, 1999; U.S. Pat. No. 5,993,632 entitled “Method and apparatus for fractionation using generalized dielectrophoresis and field flow fractionation,” filed Feb. 1, 1999 and issued Nov. 30, 1999; U.S. patent application Ser. No. 09/395,890 entitled “Method and apparatus for fractionation using generalized dielectrophoresis and field flow fractionation,” filed Sep. 14, 1999; U.S. patent application Ser. No. 09/883,109 entitled “Apparatus and method for fluid injection,” filed Jun. 14, 2001; U.S. patent application Ser. No. 09/882,805 entitled “Method and apparatus for combined magnetophoretic and dielectrophoretic manipulation of analyte mixtures,” filed Jun. 14, 2001; U.S. patent application Ser. No. 09/883,112 entitled “Dielectrically-engineered microparticles,” filed Jun. 14, 2001; U.S. patent application Ser. No. 09/883,110 entitled “Systems and methods for cell subpopulation analysis,” filed Jun. 14, 2001; U.S. patent application Ser. No. 10/005,373 entitled “Particle Impedance Sensor,” by Gascoyne et al., filed Dec. 3, 2001; U.S. patent application Ser. No. 10/028,945 entitled “Dielectric Gate and Methods for Fluid Injection and Control” by Gascoyne et al., filed Dec. 20, 2001; U.S. patent application Ser. No. 10/027,782 entitled “Forming and Modifying Dielectrically-Engineered Microparticles” by Gascoyne et al., filed Dec. 20, 2001; U.S. patent application Ser. No. ______ entitled “Droplet-Based Microfluidic Oligonucleotide Synthesis Engine” by Gascoyne et al., filed Jan. 3, 2003; and U.S. patent application Ser. No. ______ entitled “Proofreading, Error Deletion, and Ligation Method for Synthesis of High-Fidelity Polynucleotide Sequences” by Gascoyne et al., filed Jan. 3, 2003; each of which is herein incorporated by reference.

Yet another application that may be used in conjunction with the teachings of the current invention include those described in “Micromachined impedance spectroscopy flow cytometer of cell analysis and particle sizing,” Lab on a Chip, vol. 1, pp. 76-82 (2001), which is incorporated by reference.

### II. WALL-LESS CHANNELS

The wall-less channels of one embodiment of the current disclosure may be regions such as stripes or other patterns that are defined by polar surface coatings. This wall-less channel may be used with polar solvents and defined by polar surface patterning of narrowly separated top and bottom walls of a chamber filled elsewhere by a non-polar partitioning medium. This provides a simple and easy-to-fabricate interface between the micro and macro worlds in which microfluidic processes are separated from the macro world fluid flow by a narrow veil of immiscible fluid across which an exchange of droplets can be controlled electrically.

When using a droplet-based scheme such as the droplets of a PFP combined with the more conventional scheme of continuous fluid columns in microchannels, problems may arise from the hybrid scheme, such as how to interface the tiny metered reagent droplets with the continuous fluid phase and then transport them where needed. The inventors have shown that droplets spontaneously fuse to compatible fluids in capillary openings that are connected to continuous phase channel structures, but this mechanism for droplet collection has all the traditional disadvantages of dead space, of mixing, and of how to move reagents to the required reaction site. It also introduces an additional level of complexity in device fabrication and might be prone to blockage by beads and by samples or debris fed into the device from an input port.

To prevent these and similar problems, a wall-less “virtual” channel may be used for confining the continuous fluid phase. Surface energy effects confine polar fluids to the polar-coated channel region and exclude the non-polar partitioning medium to the non-polar coated regions. The polar fluid in the virtual channel comes into contact with the partitioning medium only where the two coating types interface. This scheme retains polar fluids in the wall-less virtual channel and partitioning fluid in the PFP, while allowing reagent droplets to be introduced into the polar phase at any position along its side.

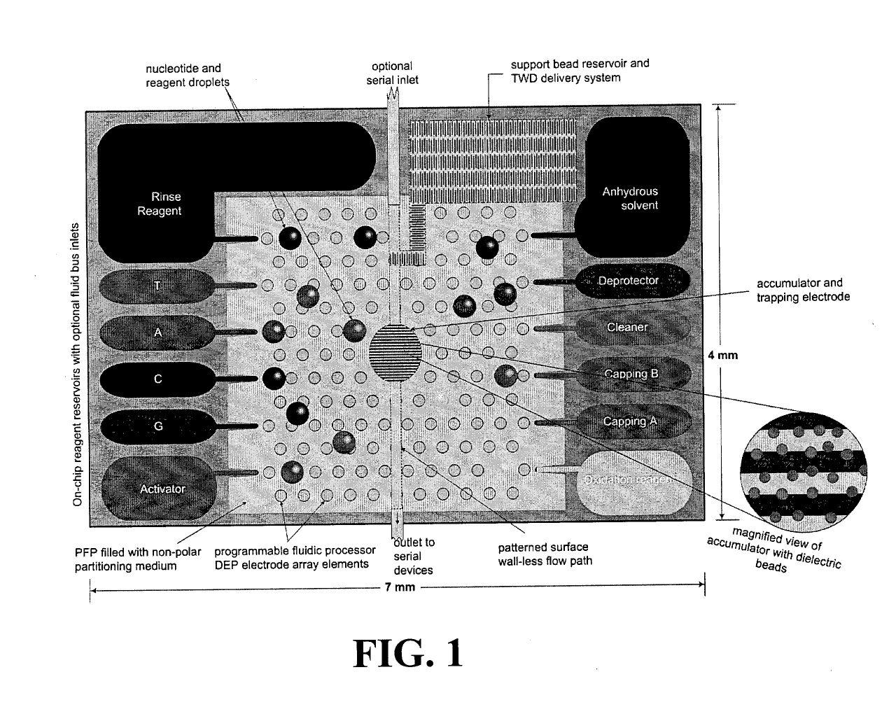

A schematic drawing of a device using an embodiment of a wall-less channel is shown in FIG. 1 where a PFP is configured for operation as an oligonucleotide synthesis engine (OSE).

Dielectrophoretic (DEP) injection of sample droplets from flow-through ports allows seamless interfacing of the macro and micro-fluidic worlds. Injectors for samples can be configured with tubes that flow to the biochip where the wall-less channels then allow for sample flow through the biochip, and the sample can be extracted from the channel at any point using a manipulation force such as a dielectrophoresis-generated force. By allowing the sample stream to flow continuously, periodic micro-sampling of fresh samples can be conducted without the need to pressurize or pump the samples and without the problem of accumulation of stale, unused samples in channels leading to the injectors.

A narrow separation between the top and bottom surface of a wall-less channel can be formed by a spacer element such as an o-ring, multiple pillar-like structures in the PFP, or by an external structure of the PFP. In one embodiment, a suitable narrow separation may be between 20 μm and 1000 μm, or more preferably between 50 μm and 200 μm in thickness. However, those having skill in the art will recognize that other suitable separation distances can be used to form wall-less channels.

For some applications, a non-polar channel with surrounding polar regions may be used. This is useful if non-polar packets and fluids are used in a reaction or other procedure.

a. Accumulators

To eliminate dead space and provide for greater programmability and flexibility with respect to the addition of reagents and rinses, a wall-less accumulator may be included. In addition to the wall-less channel, regions of the chamber top and bottom surfaces can be patterned with polar and non-polar materials to create accumulators which can be reaction surfaces, reservoirs or analysis areas. These polar areas can be separated from each other and from any channels running through a PFP by non-polar regions. Fluid can be moved from one area or channel to another, for example, by dielectric manipulation. A variety of different patterns can be formed, based on the intended use of the PFP device.

One use of an accumulator is to store reactants before use, such as a bead reservoir or a reservoir for enzymes and other substrates needed for oligonucleotide synthesis. An accumulator can also be used as a reaction area in which different reactants are combined. The accumulator may contain combs or other protrusions that can be used, for example, to hold beads in the accumulator while a fluid is being perfused through the area.

b. Packet Fusing

Polar fluid packets, when manipulated to contact a wall-less channel containing a flowing polar fluid such as water, fuse to the channel. The packet may then be carried with the polar fluid through the channel.

When forces applied to a packet by dielectrophoresis exceed the effective adhesion forces joining the packet to the fluid channel and the column of fluid within it, the packet separates from the fluid channel and is pulled towards the collection electrode in the non-polar region. Similarly, when forces applied to a packet exceed the effective adhesion forces joining the packet to an accumulator area, the packet separates from the accumulator and is pulled towards the fluid channel or other area of the PFP.

Once one packet has been routed out of a fluid channel, additional packets may be manipulated so that they fuse with the first packet to form a larger packet. Fluid may be metered out, and packets of different sizes may be made. Once introduced, packets may be used in situ or manipulated and moved to desired locations by dielectrophoresis, traveling wave dielectrophoresis, or any other suitable force mechanism, including, but not limited to, mechanical, electrical, and/or optical forces.

### III. SURFACE INTERACTIONS

Surface and interfacial energies determine how macroscopic liquid droplets deform when they adhere to a surface and how they will be confined to one region as opposed to another of different interfacial energy. The total surface energy can be described by the contact angle of the liquid on the surface. For a homogeneous solid substrate, the contact angel θ satisfies the Young equation: cos(θ)=(σᵥₛ−σ_{LS})/(σ_{LV} where σ_{VS}−σ_{LS} and σ_{LV} are the vapor-solid, liquid-solid and liquid-vapor interfacial tensions respectively.

Hydrophilic and hydrophobic patterning of surface and exploitation of the resulting molecular and aqueous affinities may be used in embodiments herein to create a wall-less channel for fluid routing and confinement. A hydrophobic surface is inert to water in the sense that it cannot bind to water molecules via ionic or hydrogen bonds. Hydrophobic forces between two macroscopic surfaces have a long range and decay exponentially with a characteristic decay length of about 1-2 nm and the range of 0-10 nm, and then more gradually farther out. The hydrophobic force can be far stronger than van der Waals attractions, and its magnitude falls with decreasing hydrophobicity (increasing hydrophilicity) of surfaces as determined from the contact angle of water on the surface or interfacial energy. At separations greater than 10 nm, the hydrophobic attraction depends on the intervening electrolyte, or carrier fluid, and in dilute solutions or solutions containing divalent ions, the hydrophobic effect can exceed the van der Waals attraction out to separations of 80 nm.

Hydrophilic and hydrophobic interactions between fluids and surfaces may become extremely potent on the microscale and may be used as one basis for controlling molecular adhesion, valving between microchannels, and other useful effects in microfluidic applications by using virtual, wall-less channels as described herein.

The effective difference between hydrophilic/hydrophobic and polar/non-polar may be slight when the system contains water or buffer as the polar fluid, and can be used interchangeably. Polar molecules can be characterized as having a permanent electric dipole while non-polar molecules do not have a permanent electric dipole. Hydrophilic and hydrophobic, on the other hand, are defined solely on the affinity towards water.

Capillary forces may also be prominent for systems on this size scale. Capillarity is the tendency of wetting fluids to migrate by a wicking action into empty capillary or pore spaces. Through capillarity, liquids such as water spontaneously flow from a reservoir into a small tube. The driving force of capillarity is measured by the capillary pressure: Δp=2γ/r where γ is the surface tension of the fluid, and r is the radius of curvature of the liquid meniscus advancing into the capillary space. Capillary forces can be used in embodiments of the current disclosure for movement of a packet from a wall-less channel or accumulation area into a capillary channel by manipulating the packet to a position at a capillary channel entrance.

a. Interactions on Patterned Surfaces

When water is continually condensed onto a single striped hydrophilic/−hydrophobic surface, a stripe of water is formed and completely covers the hydrophilic region of the surface. The loaded striped surface may have the shape of a cylindrical cap and the contact between the water and the surface may remain at the hydrophilic/hydrophobic domain boundary. Studying a single surface with an array of polar pathways, it becomes apparent that shape instabilities occur when channels become overloaded. This may appear as a bulge in the fluid path, which may be useful for forming a microbridge between two different channels. The shape instability occurs more readily at corners where the fluid can maximize its contact with the hydrophilic stripe. However, this method of fluid exchange may be limited to certain points (corners) or a random event if no corners exist and may only occur when the fluid channels are overloaded. The probability of shape instabilities is lessened when both a top and bottom hydrophilic stripe is used as a fluid channel. However, this technique is useful to control the volume of fluid in the fluid channel to prevent shape instabilities.

b. Dielectrically-Induced Forces on a Packet

In one embodiment, electrical forces may be used to influence the formation of packets from within a wall-less channel or accumulator. In another embodiment, electrical force may be used to manipulate a packet such that it fuses to a wall-less channel. Because the electrical equations are geometry dependent, however, the theoretical discussion presented here is meant to be illustrative only and not limiting. Specifically, it illustrates physical principles rather than providing specific equations applicable to all different geometrical arrangements. One having skill in the art will recognize that in any given embodiment, the exact form of the equations may differ somewhat from those presented here, but the physical principles governing packet injection will be similar, if not the same. Thus, having the benefit of the illustrative examples given herein, equations and solutions applicable to arbitrarily different arrangements will be readily apparent to those having skill in the art.

If a small sphere of a first dielectric material (which may include a solid, liquid or gas) is introduced into a second, dissimilar dielectric material to which an electrical field is applied, the energy of the combined system of dielectric materials will be changed, in comparison with the energy before the introduction occurred, as the result of the difference in the polarizabilities of the two dielectric materials. This energy change is proportional to W, which may be approximated as

W=2πεₛr³f_{CM}\overline{E}²

where \overline{E} is the electrical field, εₛ is the permittivity of the second dielectric material, r is the radius of the small sphere, and \overline{E} is the applied electrical field. The term f_{CM} is the so-called Clausius-Mossotti factor, known in the art, that expresses the polarizability of the sphere in terms of the differences between complex dielectric permittivities of the first material, ε*_{f}, and that of the second material, ε*ₛ, and, if the electrical field is not traveling through space, is given by

$${f}_{CM} = Re ( \frac{{ϵ}_{f}^{*} - {ϵ}_{s}^{*}}{{ϵ}_{f}^{*} + 2 {ϵ}_{s}^{*}} ) .$$

For the present discourse, assume that the first dielectric material is the fluid that is about to be channeled to the reaction surface and that the second material is an immiscible liquid or gas that surrounds the wall-less channel. The second liquid or gas may be called the “partitioning fluid.”

If it is assumed that the electrical field arises from a voltage V applied between the fluid in the wall-less channel and a second, pointed electrode positioned a distance d outside the wall-less channel and within the suspending medium, then, to illustrate the effects on packet pressure, the potential configuration can be approximated as being broadly similar to that produced by a source of strength V/2 and a sink of strength −V/2 of a vector field positioned at the origin and Z=d in the two dimensional complex plane, respectively. By superposition theory, the potential distribution in the z-plane is then

$$V ( z ) = \frac{V}{2} [ log ( z ) - log ( z - d ) ] .$$

Differentiating with respect to z the vector field and field gradient are obtained, respectively, as

$$\overline{E} ( z ) = ( \frac{Vd}{2} ) ( \frac{1}{z ( d - z )} ) and \frac{\partial \overline{E} ( z )}{\partial z} = - ( \frac{Vd}{2} ) ( \frac{d - 2 z}{{{z}^{2} ( d - z )}^{2}} ) .$$

Substituting these expressions into that for the pressure change at the fluid-suspending medium interface, the following equation is obtained:

$$P = \frac{{ϵ}_{s}}{2} {{f}_{CM} ( \frac{Vd}{2} )}^{2} ( \frac{1}{{{z}^{2} ( d - z )}^{2}} ) \{ \frac{3}{2} - \frac{r ( d - 2 z )}{z ( d - z )} \} .$$

The pressure induced electrically depends upon the square of the voltage V, implying not only that the direction of the applied voltage is unimportant but that alternating current (AC) fields may be used. In practice, the use of AC fields is advantageous because fields of sufficiently high frequency may be coupled capacitively from electrodes insulated by a thin layer of dielectric material (such as TEFLON or any other suitable insulating material) into chambers where fluid packet manipulations are to be carried out. In addition, the use of AC fields permits the frequency dependencies of the dielectric permittivity of the fluid, ε*_{f}, of the suspending medium, and that of any matter within the fluid, to be exploited if desired. These frequency dependencies result in different behavior of the materials at different applied field frequencies and, under appropriate circumstances, may result in useful changes in the direction of dielectrophoretic forces as the frequency is varied.

To an approximation, the effect of the electrical field on packet formation at the wall-less channel may be judged by examining the pressure properties along the x axis at the position z=r. Substituting this condition into the pressure equation in the early stages of packet formation when r is small compared to the distance d to the other electrode, the following approximate expression may be written:

$$P \approx \frac{{ϵ}_{s}}{2} {{f}_{CM} ( \frac{V}{2 r} )}^{2} \{ \frac{3}{2} - 1 \} = \frac{{ϵ}_{s}}{4} {{f}_{CM} ( \frac{V}{2 r} )}^{2} .$$

In this case, the pressure change at the fluid-suspending medium interface is dominated by the dielectric energy resulting from displacement of the suspending medium. This pressure change does not depend upon net charge on the packet.

In one embodiment, the dielectrophoretic forces may be generated by an array of individual driving electrodes fabricated on an upper surface of a reaction surface. The driving electrode elements may be individually addressable with AC or DC electrical signals. Applying an appropriate signal to driving electrode sets up an electrical field that generates a dielectrophoretic force that acts upon a packet. Switching different signals to different electrodes sets up electrical field distributions within a fluidic device. This can be used for the manipulation of different packets into and out of wall-less channels and accumulators within the device. Such electrical field distributions may be utilized to introduce packets into a partitioning medium.

Pressure hold-off characteristics can also be used for the controlled injection of fluid into the wall-less channels. This pressure mediated valving of the channel is one method for controlling fluid flow.

### IV. FORMATION OF POLAR/NON-POLAR REGIONS

In one embodiment, regions of a chamber top and bottom surfaces can be patterned with various hydrophilic and hydrophobic materials. These modified surfaces can be produced by a variety of techniques such as microcontact printing (Lopez et al, 1993; Drelich et al., 1994; Morhard et al., 1997, each of which is incorporated herein by reference), vapor deposition (Jacobs et al., 1997; Gau et al., 1999, each of which is incorporated herein by reference), and photolithography (Wang et al, 1997; Moller et al., 1998, each of which is incorporated herein by reference).

a. Silanization

Silanization is a chemical procedure for surface modification, and can be used for creating a patterned surface using, for example, microcontact printing. Surfaces can be made highly hydrophilic by forming a surface with alkyl silanes such as an octadecyl silane. Mono-, di- and tri-functional silanes may be used, such as octadecyltrimethoxy silane and octadecyltrichloro silane. Other silanes can also be used to form surfaces of differing hydrophobicity and polarity. For example, 3-aminopropyltriethoxy silane can be used to form a surface with terminal amines. A silane useful in the fabrication of the devices, PDMS, which has a non-polar surface, may be made polar by surface oxidation.

When silanizing a surface, it is important to have a clean and dry substrate. This can be accomplished using various cleaning procedures known in the art, or starting with a substrate that has not been exposed to a dirty atmosphere since its manufacture. Cleaning solutions that can be used for glass substrates include piranha solution (sulfuric acid and hydrogen peroxide). Other cleaning procedures include plasma cleaning and cleaning with NaOH.

b. Surface Oxidation

A surface may be made hydrophilic or more hydrophilic by oxidation. This involves oxidizing the uppermost layer of the surface to form hydroxyls, carbonyls, carboxylic acids, and other oxygen rich functional groups. Surface oxidation may be done by the use of plasma, ultraviolet light, or electron beams as energy sources in the presence of oxygen and air.

Oxidative treatments by flame treatment, corona discharge, UV irradiation and chemical oxidation (i.e. treatment with an oxidizing acid solution) generally lead to an increased hydrophilicity of the surface. Plasma treatment and/or plasma polymerization can also be used to alter the hydrophobicity of the surface by the selective incorporation of different types of chemical species onto the surface through the use of an appropriate treatment gas or a monomer under controlled reaction conditions. This oxidation process can be carried out in a radio-frequency plasma chamber in an atmosphere with high oxygen content. PCT Patent Application No. SE89-00187, which is incorporated herein by reference, discloses a method of increasing the hydrophilicity of a surface by oxidation, reacting the surface groups to form stable nucleophilic groups on the surface.

Photolithography

Photolithography is the process of transferring a pattern from a mask onto a photoresist-covered surface. This process can be used to pattern hydrophilic and hydrophobic areas on a surface. The pattern is first created on a mask which is either a light-field mask having an opaque pattern image on a clear glass plate or a dark-field mask having a clear image on an opaque glass plate. The surface is dried and coated with an adhesion promoter (e.g., HMDS) and spin-coated with a light-sensitive film called photoresist (PR). The surface is again dried to remove solvent and strengthen adhesion to the surface, which prevents it from sticking to the mask. Using a mask alignment tool, the mask and surface are brought together and aligned. An ultraviolet light source exposes the PR that is not covered by the opaque portions of the mask. The surface is then placed in a chemical solution (developer) which dissolves either the exposed or unexposed areas of PR, depending on the type of PR being used. Depending on the chemical properties of the substrate under the PR, this process can be used to form patterned surfaces with variety of different energies.

When a positive photoresist is used, the areas exposed to UV light are chemically altered so that they are dissolved away in the developer, leaving PR on the surface only in those places where the mask was opaque. This is known as positive photolithography, and is more commonly used.

With a negative photoresist, the exposed area becomes chemically active so that the polymer in the PR cross-links. This cross-linked polymer is no longer sensitive to light or the developer, and so the resist that was not cross-linked is developed away, leaving the “hardened” cross-linked PR behind. Since the cross-linked resist remains in those areas that were not opaque on the mask, this is known as negative photolithography, or image reversal lithography.

d. Other Surface Treatments

There are numerous methods for surface modification known in the art to make a surface more or less hydrophilic/polar. These methods include, but are not limited to, the addition of amino groups by fuming of nitrous acid (Rubin et al., 1980), bromoacetylation (Peterman et al., 1988), and chemical grafting (Hoffman et al., 1991).

### V. EXAMPLES

The following examples are included to demonstrate specific embodiments of the invention. It should be appreciated by those of skill in the art that the techniques disclosed in the examples which follow represent techniques discovered by the inventor to function well in the practice of the invention, and thus can be considered to constitute specific modes for its practice. However, those of skill in the art should, in light of the present disclosure, appreciate that many changes can be made in the specific embodiments which are disclosed and still obtain a like or similar result without departing from the spirit and scope of the invention.

### Example 1

A schematic drawing of a device having wall-less channels according to one embodiment of the present disclosure is shown in FIG. 1. The device is a 4 mm×7 mm unit cell module. The left- and right-most sections contain on-chip reagent reservoirs that may optionally be interfaced to a fluidic bus. The central portion includes a programmable fluidic processor (PFP) that uses dielectrophoresis (DEP) to inject small (5 nL) droplets of reagents on demand from the reservoirs into the PFP reaction space where they are routed along arbitrarily-programmable paths defined by DEP forces provided by the two dimensional array of electrodes. The reaction space is filled with a low-dielectric constant, immiscible partitioning fluid medium such as decane or bromodoecane. The DEP injection provides fluid metering and valving actions required for synthesis, including flushing completed oligonucleotides from the synthesizer. The electrode array may be passivated with an inert coating (e.g. TEFLON) to eliminate the possibility of surface contamination or contact of reagents with the metal electrodes. In order to further obviate chemical interactions with device surfaces, oligonucleotides may be synthesized on the surfaces of mobile, solid phase supports developed for this purpose rather than on a device itself. These supports may be 10 micron beads (or beads of other size) engineered so as to give them well-defined dielectric properties that permit them to be tapped and released by DEP as required. The bead supports may be stored in an on-chip reservoir (top right of the center channel) and metered and dispensed on demand by traveling wave dielectrophoresis (TWD) provided by a four-phase TWD electrode track on the bottom surface of the reservoir.

One feature of this design is that the continuous fluid channel is wall-less: polar reagents are confined to it by surface forces derived from patterning a polar coating onto both the top and bottom surfaces of the thin reaction chamber. This provides a low surface contact energy region for polar solvents that contrasts with the high surface-energy interaction that would occur between these reagents and the non-wettable, non-polar coatings of other surface regions of the device. Conversely, the non-polar partitioning medium in the PFP preferentially associates with the non-polar surface coatings and avoids the polar-coated surface. For these reasons, the polar region provides a low-energy pathway that tends to confine polar fluids and reaction chemistries. A significant feature of this wall-less channel is that reagent droplets may be introduced non-mechanically from the PFP by DEP manipulation at any location along its side. The wall-less channel scheme coupled with the PFP technology provides a simple and easy-to-fabricate interface between micro and macro environs.

While the present disclosure may be adaptable to various modifications and alternative forms, specific embodiments have been shown by way of example and described herein. However, it should be understood that the present disclosure is not intended to be limited to the particular forms disclosed. Rather, it is to cover all modifications, equivalents, and alternatives falling within the spirit and scope of the disclosure as defined by the appended claims. Moreover, the different aspects of the disclosed apparatus and methods may be utilized in various combinations and/or independently. Thus the invention is not limited to only those combinations shown herein, but rather may include other combinations, as well.

### REFERENCES

Each of the following references is specifically incorporated herein by reference in its entirety:

Schnelle T, Muller T, Gradl G, Shirley S G, Fuhr G. “Dielectrophoretic manipulation of suspended submicron particles.” Electrophoresis 2000 Jan;21(1):66-73 .

Fiedler S, Shirley S G, Schnelle T, Fuhr G. “Dielectrophoretic sorting of particles and cells in a microsystem.” Anal Chem May 1, 1998;70(9):1909-15.

Washizu M, Jones T B, Kaler K V. “Higher-order dielectrophoretic effects: levitation at a field null.” Biochem Biophys Acta Aug. 20, 1993;1158(1):40-6.

Green NG, Morgan H, Milner J J. “Manipulation and trapping of sub-micron bioparticles using dielectrophoresis.” J Biochem Biophys Methods Sep. 25, 1997;35(2):89-102.

Chien Y Y, Pearce E M, and Kwei T K, “Ultraviolet Radiation-Induced Oxidation of Polymer Mixtures,” Polym Prepr, 29:548-549, 1988.

Drelich et al., Colloids Surf. A, 93, 1, 1994.

Moller et al., Langmuir 14, 4955, 1998.

Gau et al. “Liquid Morphologie on structured surfaces: From microchannels to microchips” Science 283 46-49, 1999.

Hoffman A S, Kiaci D, Safranj A, et al, “Binding of Proteins and Platelets to Gas Discharge-Deposited Polymers,” Clin Mat, 8:3-8, 1991.

Jacobs et al., Proceedings of the 2^{nd} European Coating Symposium, Strasbourg, 1997.

Koritskii A T, and Nikol'skii V G, “Radical Ions as Initiating Agents in Radiation-Induced Oxidation of Polymers,” Khim Vys Energ, 21:235-240, 1987.

Munro H S, “The Surface Photooxidation of Polymers,” Polym Mater Sci Eng, 58:344-348, 1988.

Pearce E M, Kwei T K, and Chien Y Y, “Ultraviolet Radiation Induced Oxidation of Polymer Mixtures,” Polym Prepr, 28:305-306, 1987.

Peterman J H, Tarcha P J, Chu V P, et al., “The Immunochemistry of Sandwich-ELISAs. IV. The Antigen Capture Capacity of Antibody Covalently Attached to Bromoacetyl Surface-Functionalized Polystyrene,” J Immunol Meth, 111:271-275, 1988.

Wang et al., Nature 388, 431, 1997.

Lopez et al., Science 260, 647, 1993.

Rubin R L, Hardtke M A, and Carr R I, “The Effect of High Antigen Density on Solid-Phase Radioimmunoassays for Antibody Regardless of Immunoglobulin Class,” J Immunol Meth, 33: 277-292, 1980.

Zhao et al., “Surface-directed liquid flow inside microchannels” Science 29, 9, 1023-1026, 2001.

What is claimed is:

1. An apparatus for routing a fluid packet comprising:
a top surface comprising a polar pathway and a non-polar region;
a bottom surface comprising a polar pathway and a non-polar region;
wherein said polar pathway of said top surface is above said polar pathway of said bottom surface, forming a polar channel; and
a conductor configured to generate a programmable manipulation force via an electric field, the programmable manipulation force being configured to move a packet into and out of fluid contact with said polar channel.

2. The apparatus of claim 1, wherein said top and bottom surfaces are separated by 0.2 mm-0.4 mm.

3. The apparatus of claim 1, wherein said manipulation force comprises a dielectrophoretic force.

4. The apparatus of claim 3, wherein said manipulation force comprises a dielectrophoresis-induced force.

5. The apparatus of claim 1, further comprising a polar region on said top surface and said bottom surface wherein said polar region of said top surface is directly above said polar region of said bottom surface.

6. The apparatus of claim 5, wherein said polar region comprises an accumulator, a reaction surface or an analysis area.

7. The apparatus of claim 1, wherein said polar pathways are formed by surface oxidation of said top and bottom surface.

8. The apparatus of claim 1, wherein said non-polar region is formed by silanization of said top and bottom surface.

9. The apparatus of claim 1, wherein said fluid contact of fluid packet with said polar channel occurs at any point along said polar channel.

10. The apparatus of claim 1, wherein said polar channel runs substantially through the center of the apparatus.

11. The apparatus of claim 1, wherein said polar channel runs substantially at an edge of the apparatus.

12. The apparatus of claim 1, wherein said polar channel is adapted for continuous fluid flow through said polar channel.

13. The apparatus of claim 12, wherein said fluid is water or buffer.

14. The apparatus of claim 1, further comprising a second apparatus fluidically linked to said apparatus.

15. The apparatus of claim 1, further comprising a comb electrode wherein said comb electrode is attached to said top or bottom surface.

16. The apparatus of claim 1, further comprising a second polar pathway.

17. The apparatus of claim 1, wherein said polar channel is adapted for valving using a hold-off pressure.

18. A method for fluid routing comprising:
flowing a polar fluid through a polar channel;
manipulating a packet in a non-polar region of the channel; and
subjecting said packet to a manipulation force wherein said packet fuses with said polar fluid in said polar channel.

19. The method of claim 18, wherein, said polar channel comprises a top surface comprising a polar pathway surrounded by a non-polar region and a bottom surface comprising a polar pathway surrounded by a non-polar region and wherein said polar pathway of said top surface is directly above said polar pathway of said bottom surface.

20. The method of claim 18, further comprising a non-polar partitioning medium.

21. The method of claim 18, wherein said manipulation force comprises a dielectrophoretic force, an electrophoretic force, an optical force, a mechanical force, a light source, or any combination thereof.

22. The method of claim 21, wherein said manipulation force comprises dielectrophoresis.

23. The method of claim 18, wherein said polar fluid is flowed continuously through said polar channel.

24. The method of claim 18, wherein said polar fluid is water or buffer.

25. The method of claim 18, further comprising simultaneously subjecting a plurality of packets of immiscible fluid to a manipulation force.

26. The method of claim 18, further comprising valving said polar channel using a hold-off pressure.

27. The method of claim 18, wherein said fluid contact of fluid packet with said polar channel occurs at any point along said polar channel.

28. The method of claim 18, wherein said packet is obtained from an accumulator.

29. The method of claim 28, wherein said accumulator comprises comprising a polar region on said top surface and said bottom surface wherein said polar region of said top surface is directly above said polar region of said bottom surface.

30. The method of claim 28, wherein said packet is involved in a chemical or biological reaction in said accumulator prior to fusing with said polar fluid in said polar channel.

31. The method of claim 18, wherein said packet is used in oligonucleotide synthesis.

32. The method of claim 18, wherein said packet is used in bead delivery.

33. A method for fluid routing comprising:
flowing a polar fluid through a polar channel comprising a top surface comprising a polar pathway surrounded by a non-polar region and a bottom surface comprising a polar pathway surrounded by a non-polar region; wherein said polar pathway of said top surface is directly above said polar pathway of said bottom surface forming a polar channel; and
subjecting a portion of said polar channel to a manipulation force wherein a portion of said polar fluid moves from said polar channel into said non-polar region defining a packet of polar fluid.

34. The method of claim 33, wherein said packet moves from said polar channel to a capillary opening.

35. The method of claim 33, wherein said portion of polar channel subjected to a manipulation force occurs at any point along said polar channel.

36. The method of claim 33, further comprising moving said packet into an accumulator.

37. The method of claim 36, wherein said packet is involved in a chemical or biological reaction in said accumulator.

38. The method of claim 36, wherein said packet is used in oligonucleotide synthesis.

39. The method of claim 36, wherein said packet is used in bead delivery.

40. The method of claim 33, further comprising a non-polar partitioning medium in said non-polar region.

41. The method of claim 33, wherein said top and bottom surfaces are separated by 0.2 mm-0.4 mm.

42. The method of claim 33, wherein said manipulation force comprises a dielectrophoretic force, an electrophoretic force, an optical force, a mechanical force, a light source, or any combination thereof.

43. The method of claim 42, wherein said manipulation force comprises a dielectrophoresis-generated force.

44. The method of claim 33, wherein said polar fluid is flowed continuously through said polar channel.

45. The method of claim 33, wherein said polar fluid is water or buffer.

46. The method of claim 33, further comprising simultaneously subjecting a plurality of packets of immiscible fluid to a manipulation force.

47. The method of claim 33, further comprising valving said polar channel using a hold-off pressure.

48. The method of claim 33, wherein said fluid contact of fluid packet with said polar channel occurs at any point along said polar channel.
